(19) United States
(12) Patent Application Publication
(10) Pub. No.: US 2023/0325648 A1
(43) Pub. Date: Oct. 12, 2023

(54) NEURAL NETWORKS PROCESSING UNITS ACTIVATION SPARSITY REMOVAL

(71) Applicant: NEURONIX AI LABS INC., Sunnyvale, CA (US)

(72) Inventors: Asher Hazanchuk, Sunnyvale, CA (US); Yaron Raz, Sunnyvale, CA (US)

(21) Appl. No.: 18/328,631

(22) Filed: Jun. 2, 2023

Related U.S. Application Data
(63) Continuation-in-part of application No. 17/457,623, filed on Dec. 3, 2021.
(60) Provisional application No. 63/123,784, filed on Dec. 10, 2020.

(51) Int. Cl. G06N 3/063; G06N 3/0464; G06N 3/048; G06F 17/16

(52) U.S. Cl. CPC G06N 3/063; G06F 17/16; G06N 3/0464; G06N 3/048

(57) ABSTRACT

In an example, a method of activation sparsity removal includes implementing a non-zero Activation jump algorithm. Alternatively, the method includes using multiple first in first out (FIFO) memories to store non-zero activations for each vector multiplication.

### CROSS-REFERENCE TO RELATED APPLICATION

This application is a continuation-in-part of U.S. Pat. 17/457,623 filed on Dec. 3, 2021 which claims the benefit of and priority to U.S. Provisional Pat. 63/123,784 filed on Dec. 10, 2020.

The 17/457,623 application and the 63/123,784 application is each incorporated herein by reference in its entirety.

### FIELD

Some embodiments herein relate generally to neural networks processing units activation sparsity removal.

### BACKGROUND

Unless otherwise indicated herein, the materials described herein are not prior art to the claims in the present application and are not admitted to be prior art by inclusion in this section.

Cloud computing and edge computing of artificial intelligence (AI)/machine learning (ML) applications and edge devices (example: smartphones, smart cameras) or other real-time applications that require ML are computation-intensive and often require multi-core and multi-device solutions to match system-required very high processing throughput.

Therefore size-efficient and power-efficient multi-core architectures are highly desirable to reduce solution cost and power consumption. Available solutions are currently based on graphics processing unit (GPU), central processing unit (CPU), field programmable gate array (FPGA), and some dedicated Application-Specific Integrated Circuits (ASICs) and/or Application-Specific Standard Products (ASSPs). These implementation methods are typically memory-size inefficient and have larger-than-needed processing units or in the case of dedicated ASICs/ASSPs don’t have the flexibility to adapt to changing machine learning evolving models.

The subject matter claimed herein is not limited to embodiments that solve any disadvantages or that operate only in environments such as those described above. Rather, this background is only provided to illustrate one example technology area where some embodiments described herein may be practiced.

### SUMMARY

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

In an example embodiment, a method of activation sparsity removal includes implementing a non-zero Activation jump algorithm. Alternatively, the method includes using multiple first in first out (FIFO) memories to store non-zero activations for each vector multiplication.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a block diagram of an example scalable DNN accelerator (sDNA) that may include multiple NPUs;

FIG. 2 depicts an example of how weights and activations may be stored in memory of the NPUs of FIG. 1;

FIG. 3 is a block diagram of another example sDNA with acceleration of MAC operations;

FIG. 4 is an automotive application research example that articulates why it is important to accelerate real-time machine learning inferencing applications;

FIG. 5 is a table with some machine learning model examples and their potential weight and activation sparsity removal acceleration potential;

FIG. 6 is a prior art 2x weight sparsity removal example of Nvidia Ampere GPU family;

FIG. 7 is a prior art typical multipliers utilization statistics example;

FIG. 8 is an example of generalization of the serial mode sDNA architecture example described herein into a parallel mode sDNA architecture example;

FIG. 9 illustrates DNN processing unit size-reduction of the sDNA architecture processing unit compared with a typical GPU architecture;

FIG. 10 is a block diagram of another example sDNA that may include multiple address generators, multiple activation memories, and multiple NPUs;

FIG. 11 is a block diagram of examples of different implementation architectures of sDNAs: sequential execution NPUs architecture, concurrent execution NPUs architecture, or combination of sequential execution NPUs and concurrent execution NPUs architecture;

FIG. 12 is a block diagram of building 1*1 convolution, 3*3 convolution, generic n*n convolution using the same hardware building blocks; and

FIG. 13 demonstrates implementation of a 3*3 convolution with a stride of 2 using folding.

### DETAILED DESCRIPTION

Some embodiments herein relate generally to performance optimization of neural networks processing units and may include parallel processors that operate as DNN accelerators. Target devices for the implementation can be programmable logic devices, ASICs, CPUs, GPUs, tensor processing units (TPUs), digital signal processors (DSPs) and/or ASSPs. More particularly, some example embodiments relate to scalable, adaptable, hardware programmable, optimized size, low power parallel processors that target DNN for ML and/or AI applications. The sDNA architecture and the sDNA algorithm described herein may support common ML design flow (TensorFlow, Caffe, and others) with full transparency.

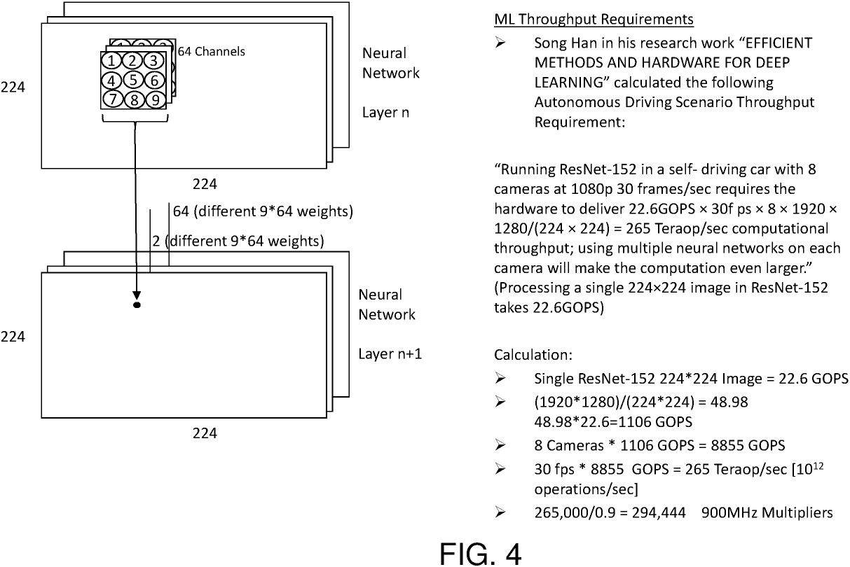

Real-time ML solutions have become very common for many AI applications. The implementation of ML is based on many layers of neural networks called deep neural networks or DNN. There are many different models of DNN: EfficientNet, ResNet, MobileNet, GoogleNet, SqueezeNet, AlexNet, Vgg, and many others. The common challenges of DNN systems in many real-time applications are a very high throughput that can reach an order of many TeraOps/second (i.e., many 10¹² operations per second). FIG. 4 is an automotive application research example that articulates why it is important to accelerate real-time machine learning inferencing applications. FIG. 4 demonstrates autonomous driving application required throughput as calculated by Song Han in his Stanford research work “EFFICIENT METHODS AND HARDWARE FOR DEEP LEARNING″

Therefore, the efficiency of the DNN system may be critical to make these applications feasible, low-cost and low-power.

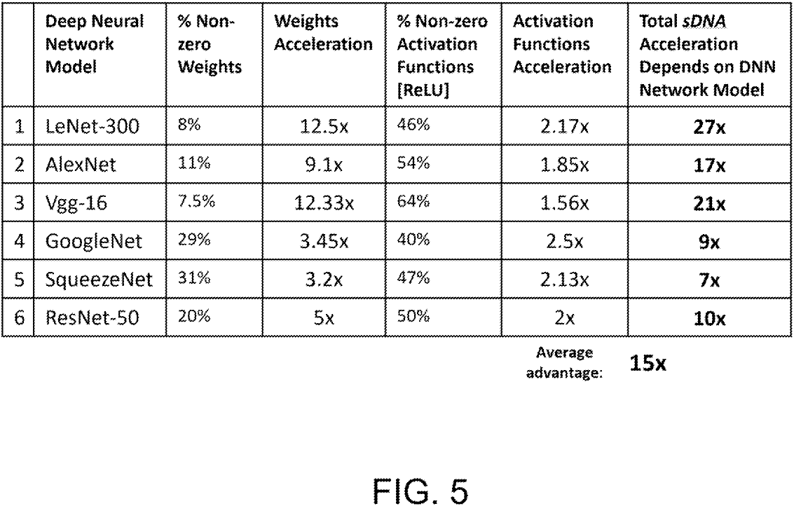

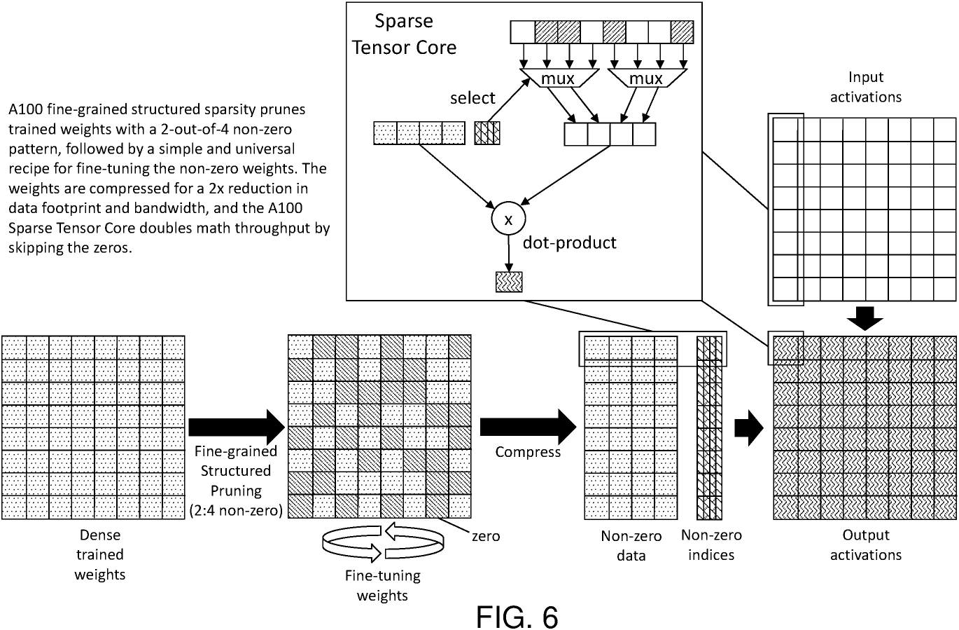

Some calculations that are done in DNN systems include multi-dimensional matrix multiplications between weights and activations multi-dimensional matrixes. A characteristic of such matrixes is that most of the weights and a significant number of activations are zero or could be forced to zero without significant effect on accuracy (quality of results). This high sparsity presents an opportunity to increase the DNN efficiency. In an example implementation, the DNN acceleration is achieved by removal of this sparsity (multiplication by zero). FIG. 5 demonstrates the approximate acceleration potential due to weight and/or activation sparsity removal of some DNN models. The design complexity is due to the irregularity of the non-zero operand locations that make it challenging to implement it in real-time, high clock rate, and high-throughput hardware. In order to overcome this sparsity irregularity-challenge some companies choose to force weight sparsity regularity called also structured sparsity. For example, Nvidia released in 2020 their Ampere GPU family that as described in FIG. 6 (source: Nvidia datasheet) forces the 2 lowest weight values out of each 4 weight values to zero. This method enables Nvidia to achieve 2x acceleration due to this weight sparsity removal.

In contrast to Nvidia’s sparsity removal method, some embodiments herein enable a full removal of all zero weights and all zero activation, regardless of structure, sparsity percentage or distribution, with no performance degradation. This DNN acceleration may be achieved by using a silicon size-efficient and power-efficient implementation as described herein that enables non-structured sparsity removal.

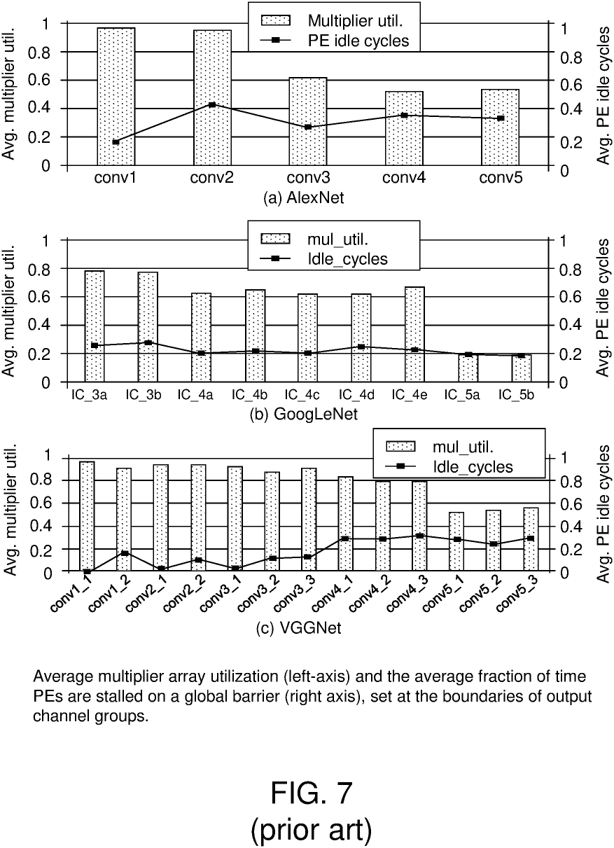

Another advantage of the sDNA architecture as described herein is that in some configurations the sDNA processing units are able independently to start a new DNN calculation and there is no requirement to wait for the other sDNA processing units to finish their calculations before starting a new DNN calculation (no synchronization requirement). This is a major efficiency and acceleration issue to other prior art competing DNN architectures as demonstrated in FIG. 7 (Source: A. Parashar/Nvidia article “SCNN: An accelerator for compressed-sparse CNN”).

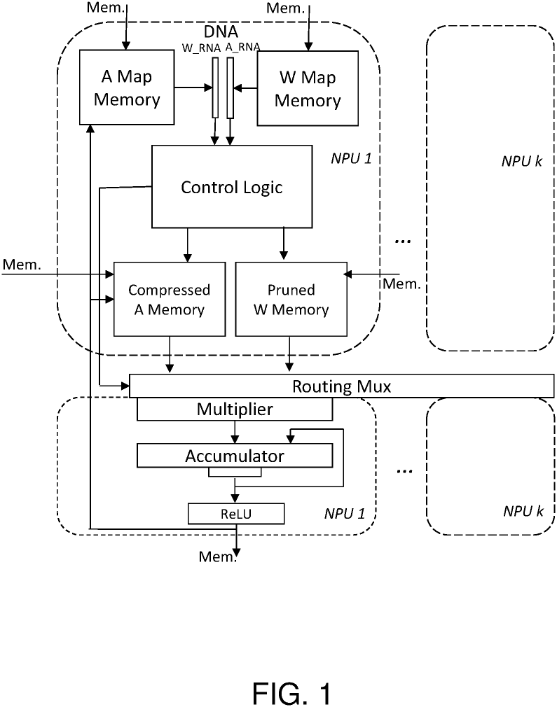

FIG. 1 is a block diagram of an example sDNA that may include multiple NPUs, arranged in accordance with at least one embodiment described herein. The sDNA may also be referred to as a DNN parallel processor based on multiple serial mode NPUs working in parallel. The sDNA or DNN parallel processor may be flexible, hardware programmable, scalable, and reconfigurable. The sDNA of FIG. 1 may be based on parallel processing of multiple NPUs and may include an activation (A) map memory and weight (W) map memory. The W map memory contains a weights bit-map of the different DNN layers. The A map memory contains an activations bit-map of the different DNN layers.

The sDNA of FIG. 1 additionally includes W_RNA and A RNA, each of which is a word of 64 bits, 32 bits, 16 bits, 8 bits, or any other bit width. A pair of W_RNA and A RNA words is a DNA word. Based on the DNA word a control logic block in the sDNA may calculate next clock addresses of a weight (W) address accumulator and an A address accumulator. These addresses point on a next weight and next activation to be fetched from a pruned W memory and a compressed A memory.

The control logic block may also calculate an amount of multiplications contained in each DNA word. This information may be used to control a routing multiplexer (mux). The routing mux may balance the calculation load of different multiplier-accumulators of the different NPUs. The multiplier-accumulators may calculate nodes (neuron’s activation functions) of the neural networks. After each vector multiplication calculation is completed optionally a non-linear operation such as ReLU or other non-linear functions may be applied before storing the non-zero results in the compressed A memory and its bit map representation at the A Map Memory or at Mem. (as will be described later).

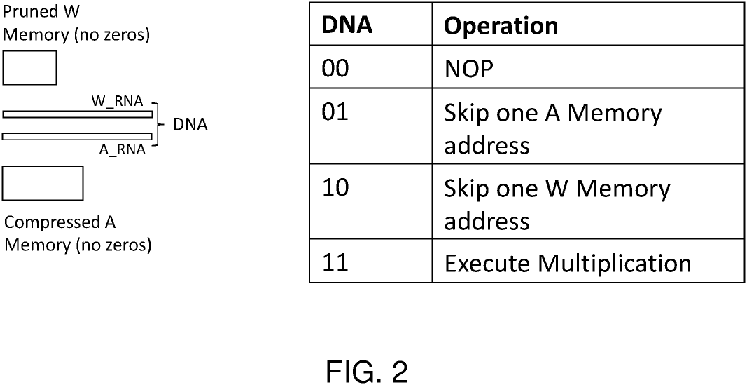

FIG. 2 depicts an example of how the weights and activations may be stored in memory of the NPUs of FIG. 1, arranged in accordance with at least one embodiment described herein. All the zero values may be removed from the original W and/or A memories (e.g., memories that include zeros that have been eliminated in the compressed A memory and the pruned W memory of FIG. 1) and the remaining W and A values may be stored compressed (e.g., without zeroes) at the Pruned W and Compressed A Memories. In addition, the W_RNA word is fetched from the W Map Memory and the A_RNA word is fetched from the A Map Memory. Each pair of W_RNA and A_RNA words create a word of DNA. As described in the table of FIG. 2 each pair of bits define a microcode operation to be executed in parallel. Multiple pairs are executed in parallel to locate the next required multiplications.

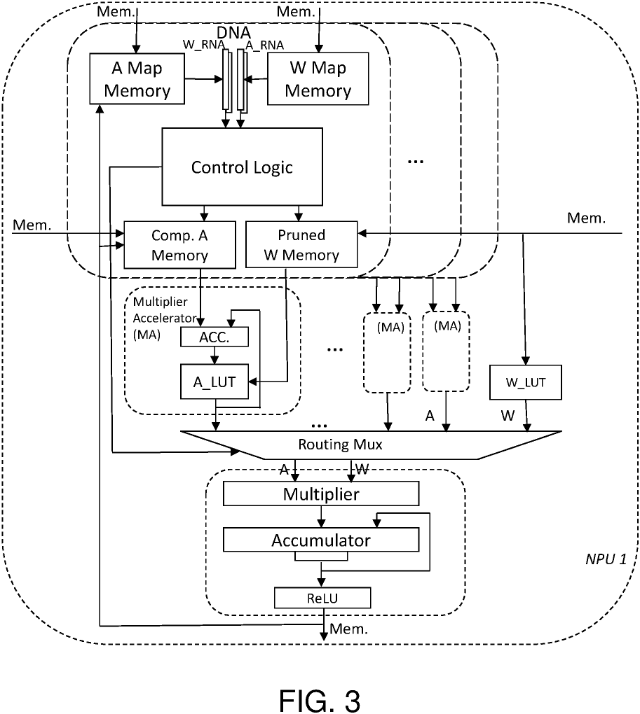

FIG. 3 is a block diagram of another example sDNA or DNN parallel processor with acceleration of MAC operations of the NPU, arranged in accordance with at least one embodiment described herein. In the example of FIG. 3, the acceleration is added into the middle of the sDNA of FIG. 1 and is described here. In FIG. 3, the output of the Pruned W Memory points to an activation_lookup table (A_LUT) memory location (address). Each location may be used for the accumulation of all the A values that need to be multiplied with specific W value. At the end of calculation of specific activation function, the A accumulations intermediate results, that resides in the A_LUT memory, is each multiplied with its matching W or de-quantized W results that resides in a weight-lookup table (W_LUT) memory. The control logic block controls the sequence of the multiply-accumulate operations and routing mux selections. The weights and activations can switch roles in different design examples.

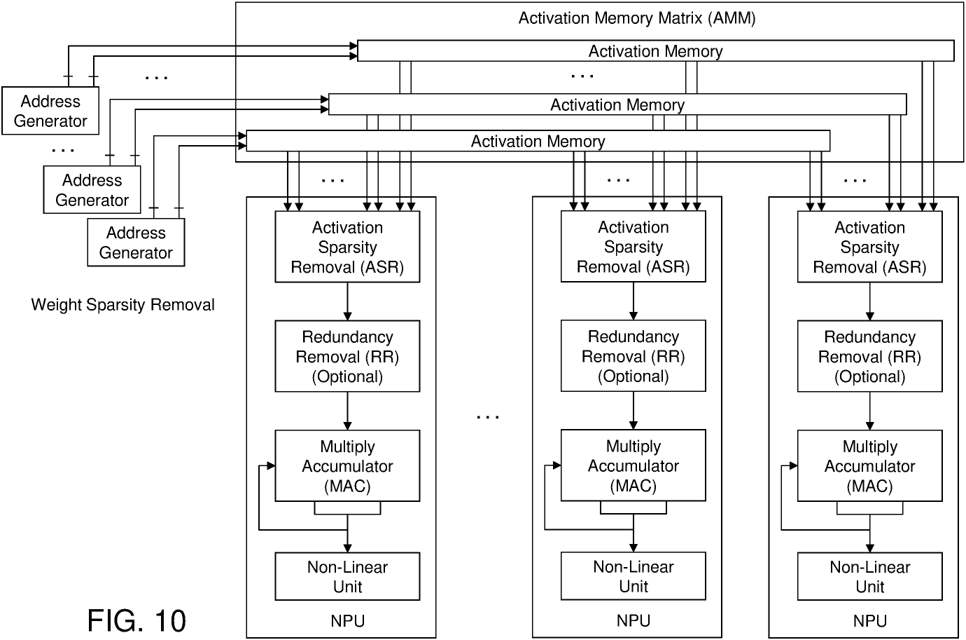

In case of neural networks that use ReLU, ReLU6 or similar non-linear output functions, if the order of the accumulations in the MAC is first accumulating all the W*A results that have positive weights and then to accumulate the W*A results that have negative weights then it is possible to achieve additional acceleration by suspending the MAC operation in case the accumulator value reaches a negative value. In order to achieve this desired sequence of operations the Address Generator of FIG. 10 (or the address of A_LUT of FIG. 3) first goes over all the addresses of the AMM that their activation is multiplied with negative weight and then continues by going over the activations that are multiplied with negative weights (the activations are always positive in case of ReLU or ReLU6 models). If during the accumulation of the negative W*A components the intermediate accumulation result turns into negative result then the full vector-multiplication accumulation result is already known to be negative at that point of the MAC calculation and the ReLU function that follows the MAC will convert it to zero. This feature is called stop-on-minus acceleration.

DNN are used in ML for AI applications. The majority of the calculations that are required for DNN implementations are multi-dimensional matrix multiplications. The multiplications are done between tensors (multi-dimensional matrixes) of weights and tensors of activations of the internal DNN layers or the sensor inputs for the first DNN layer. The multi-dimensional matrix could be a combination of two-dimensional convolution kernel, the number of current DNN layer channels, and the results dimension could be the next DNN layer number of channels. The majority of the weights and the activations may be zeroes or very close to zero (could be forced to zero). Therefore, without removing these zero multiplication operands (which is also called sparsity removal) there is a lot of inefficiency in these DNN implementations that increases the power consumption and cost of these AI/ML systems.

The sDNA of FIG. 1 may use the W Map Memory to map all the zero weights that can be skipped and the A Map Memory to map all the zero activations that can be skipped. An sDNA algorithm implemented herein may slide through each layer of the convolution neural network and by comparing the W_RNA and the A_RNA words fetched from these memories, it may calculate how many weights in the Pruned W Memory and how many activations in the Compressed A Memory may be simultaneously skipped.

As illustrated in FIG. 2, microcode of the DNA operation may be defined by each pair of DNA bits, e.g., as follows:
00 — No operation
01 — Skip one A memory address
10 — Skip one W memory address
11 — Execute multiplication
Multiple microcode instructions may be executed simultaneously in parallel.

The specific weight and activation function operands may be fetched from their respective memory locations in pruned W memory and compressed A memory and then fed to the MAC of the specific NPU after being routed through the routing mux. As indicated in FIG. 1 there may be many (e.g., k) NPUs that execute the sDNA algorithm in parallel to maintain the required DNN ML model and application throughput.

The Control Logic block in FIG. 1 may also calculate how many multiplications are required for each DNA word. This information may be used to balance the multiplications load for each NPU MAC unit. The following is an example of an sDNA algorithm that may use this information to control the data (weights and activation functions) paths in the routing mux and balance its calculation load: each MAC of NPU is allocated a DNA word with a number of multiplications that depends on its calculation’s status. The fastest NPU processing unit is allocated the DNA word with the largest number of multiplications, the second fastest NPU is allocated the DNA word with the second largest number of multiplications, and so on until the slowest NPU processing unit is allocated the DNA word with the smallest number of multiplications.

The ReLU, which is a non-linear post-processing function common to many ML models, or other non-linear post-processing functions, may be attached after the MAC and may be executed after the final result of the MAC tensor-multiplication is completed. If the ReLU result is non-zero then 1 is stored in the A Map Memory and its actual value is stored in the Compressed A Memory. Alternatively, this information can be stored in Mem.

Mem. could be an input/output (I/O) interface, internal memory or external memory (DDR for example). In the Mem. image of the activation function data or weights could be stored for later use of the sDNA algorithm.

Some embodiments herein implement a DNN with sparsity removal, as generally described above. Some embodiments herein implement a DNN with multiplier acceleration (MA), as generally described below. Alternatively or additionally, embodiments herein may implement a DNN with both sparsity removal and multiplier acceleration.

In some embodiments that implement multiplier acceleration, for example, it may be possible to take one of the operands of the multiplier, for example, pruned W which is the output of Pruned W Memory, as described in the FIG. 3 example, and to use an Accumulator (“ACC.” in FIG. 3), memory (A LUT), and the memory feedback to the Accumulator to reduce an amount of multiplications that are needed for the implementation. Each one of the W different A multiplication components may be accumulated separately. In case of a quantized W mode of operation, memory W_LUT may contain de-quantized components of W. The intermediate results may be accumulated together by the multiplier accumulator to calculate the full activation function result, before it is sent to the ReLU. The multiplier acceleration functions can be bypassed if some of them or all of them are not needed.

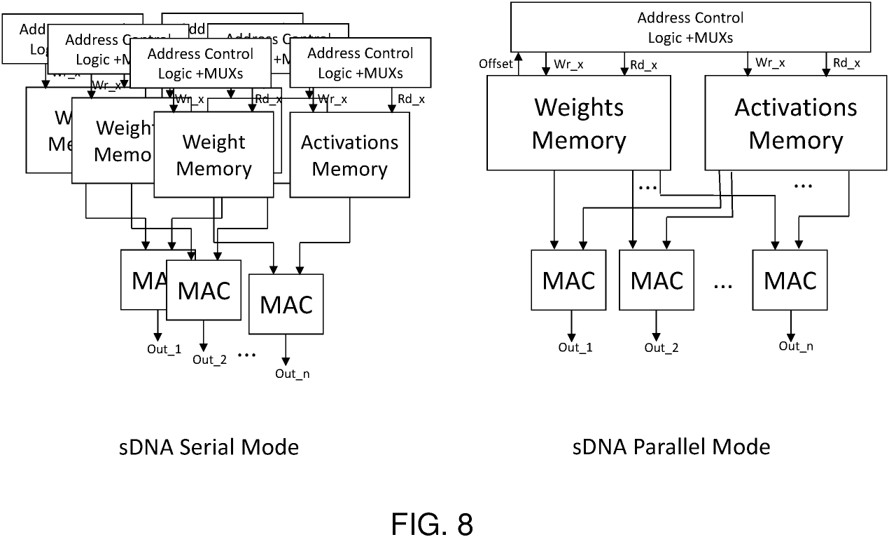

FIG. 8 is one example of generalization of the serial mode sDNA architecture example described herein into a parallel mode sDNA architecture example. As illustrated in FIG. 8, the serial mode that is described elsewhere herein, can be generalized to parallel mode to increase memory bandwidth usage. The example of FIG. 8 is only one example of how the sDNA serial mode architecture could be generalized to sDNA parallel mode architecture to achieve higher throughput and performance. Based on the Offsets generated in the Weight memories multiple activations are read in parallel and multiple Activation Function outputs are being calculated simultaneously.

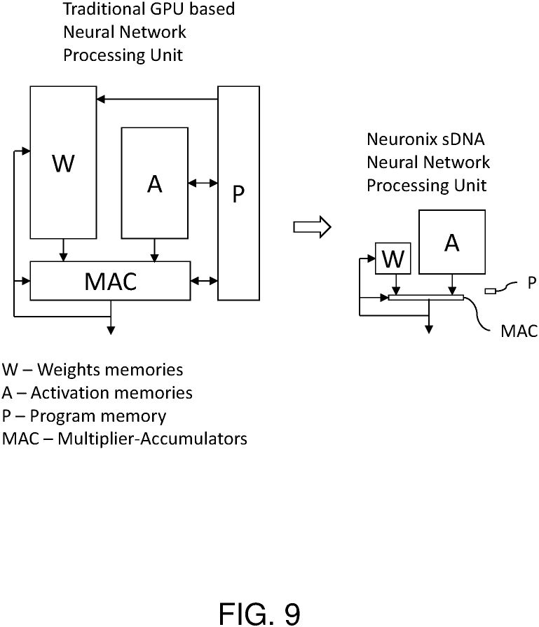

FIG. 9 demonstrates DNN processing unit size-reduction of the sDNA architecture processing unit compared with a typical GPU architecture. As described in FIG. 9, a “Neuronix sDNA architecture neural network processing unit” and its sparsity removal algorithm arranged according to embodiments herein may reduce the weights and activations memory sizes compared to traditional GPU-based NPUs. The sDNA data flow architecture significantly reduces the required program memory size. The full sparsity removal and the use of multiplier accelerator architecture are reducing the total number of multipliers required. Altogether the size of the basic sDNA processing unit is significantly reduced compared with currently commonly used DNN architectures that are based on GPU, CPU, TPU or other similar DNN solutions.

Some of the foregoing embodiments relate to an hardware implementation of algorithms for, e.g., DNN with sparsity removal and/or multiplier accelerator. Embodiments described herein may also be relevant and/or may be extended to software implementation of the algorithms. Alternatively or additionally, some embodiments herein implement a parallel expansion of one or more of the foregoing serial mode NPUs, as described with respect to, e.g., FIGS. 8 and 10-12.

Referring to FIG. 10, such a parallel sDNA architecture may include multiple Address Generator blocks that implement offsets to create Weight Sparsity Removal. An Activation Memory Matrix (AMM) stores the activation values. There are many different parallel architecture schemes that the AMM may support: Multiple points (pixels) parallel scheme, Lines parallel scheme, Multiple input channels parallel scheme, Multiple output channels parallel scheme, or other suitable parallel architecture schemes. As illustrated, the parallel sDNA architecture of FIG. 10 includes multiple NPUs, each NPU including one or more of an Activation Sparsity Removal (ASR) block, a Redundancy Removal (RR) block, a MAC, and/or a non-linear unit.

Based on the AMM parallel scheme implemented, each group of multiple AMM outputs may be used as input to a relevant Activation Sparsity Removal (ASR) block. Each Activation Sparsity Removal block may implement a non-zero Activation jump algorithm similar or identical to the RNA (one bitstream of the DNA) algorithm/architecture as described herein, and/or may use multiple first in first out (FIFO) memories to store only the non-zero activations read from the AMM (additional FIFO read control logic is used to balance the different FIFOs used capacity with the MAC operations), and/or may use an adder tree for design simplification, or may bypass the ASR to support weights only sparsity removal (i.e., weight sparsity removal without ASR). Example embodiments of the Activation jump algorithm (alternatively referred to and/or described as activation sparsity removal, removal of zero weights, or the like) are described in U.S. Pat. 17/457,623 filed Dec. 3, 2021 (and published as US Pat. 20220188611) which is incorporated herein by reference in its entirety.

The outputs of the ASR blocks may optionally feed the Redundancy Removal (RR) blocks to achieve additional MAC acceleration as described in detail in and with respect to FIG. 3. The output of the clustered/quantized weight memory (e.g., pruned W memory) points to an A_LUT memory location. Each location may be used for the accumulation of all the activation values that need to be multiplied with a specific weight value. At the end of calculation of specific activation function, the activation accumulates intermediate results, that reside in the A_LUT memory, is each multiplied with its matching weight or de-quantized weight results that reside in a weight-lookup table (W_LUT) memory. The weights and activations can switch roles in different DNN applications.

Outputs of the Redundancy Removal block, the outputs of the ASR blocks in the event the RR is not implemented or is bypassed, or the outputs of the AMM blocks in the event the ASR and the RR are not implemented or are bypassed may be used as inputs to the MAC blocks that implement machine learning tensor multiplications.

If there are more than one activation that need to be multiplied with the same weight at the same vector-multiplication calculation, then it is possible to arrange the activations in pairs and to use the 2 pointers of each Address-Generator of FIG. 10 to read a pair of activations simultaneously from the AMM and to add them together before executing their multiplication in the MAC (DSP48E and many other FPGA devices have a pre-adder built-in into their MAC inputs so this addition is free and doesn’t require additional FPGA fabric resources in these cases). In the case of highly-quantized neural networks the probability of finding pairs is much higher. This pairing innovation is a simplified RR implementation that requires less silicon area.

In order to increase the probability of finding activation pairs that are multiplied by the same Weight it is possible to use the symmetry property. It is possible to gather all the activations that need to be multiplied by the weight W or by the weight -W and pair them together to achieve additional acceleration as was described earlier (use of the 2 pointers of each Address-Generator of FIG. 10 to read a pair of activations simultaneously from the AMM and to subtract them before executing their multiplication in the MAC). In this case the pre-adder is used as an subtractor to subtract the activation that should be multiplied with negative weight (-W) from the activation that should be multiplied with positive weight (W). Then the subtraction result should be just multiplied, in the MAC of FIG. 10, by the weight W. This Symmetry property could increase by about a factor of 2 the probability of pairing and its acceleration.

Outputs of the MAC blocks may be followed by machine learning non-linear blocks such as ReLUs or other non-linear blocks.

Each non-linear block output is stored in the next layer AMM or used as feedback to the current layer of the AMM (in case of Sequential Execution NPUs architecture), to support different DNN architecture implementations.

Each Activation data read from the AMM may be used multiple times for different vector-multiplication operations.

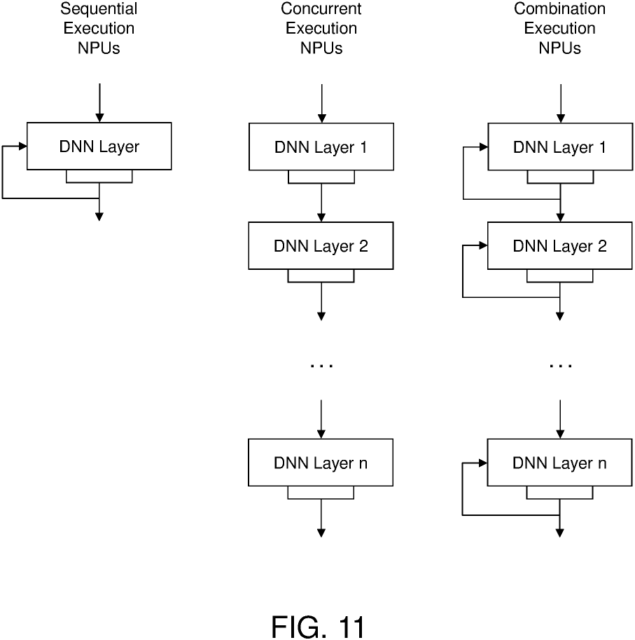

Referring to FIG. 11, embodiments of the sDNA architecture disclosed herein may support Sequential Execution NPUs, Concurrent Execution NPUs, or combination of Sequential Execution NPUs and Concurrent Execution NPUs. In the Sequential Execution NPUs architecture the output of the neural network layer is stored back (feedback) in the current layer AMM instead of being sent to the next layer AMM. In the Sequential Execution NPUs architecture, the same hardware resources may be reused to calculate the different layers of the same neural network. In the case of the Concurrent Execution NPUs architecture, different hardware resources are allocated to different DNN layers and all the layers may be processed in parallel (concurrently). The results of each layer may be sent to another hardware logic that executes the next DNN layer. The third architecture, Combination of Sequential Execution and Concurrent Execution NPUs (or “Combination Execution NPUs in FIG. 11”), is a combination of the first two architectures.

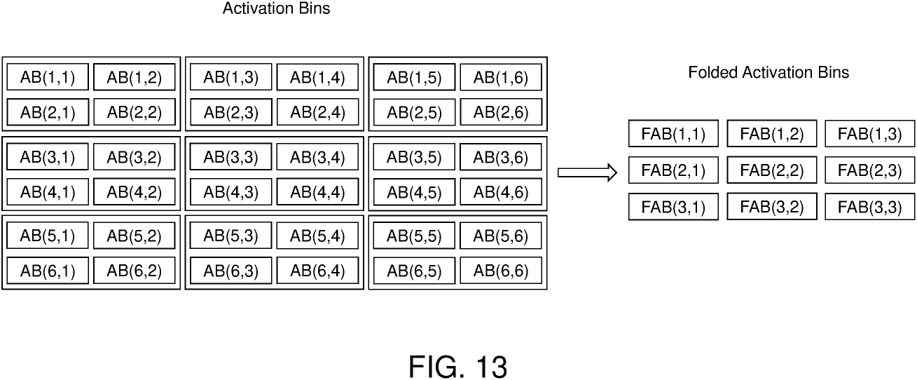

In order to implement larger kernels of convolution and/or to support larger than one strides, it is possible to fold together neighbor bins (memory sections in the AMM that store activation input channels of a pixel or a group of pixels) of activations so that the parallel operations of neighbor MAC units will be fully synchronized and there would be no loss of clock-cycles. FIG. 13 demonstrates implementation of 3*3 convolution with a stride of 2. Each group of 4 neighbor Activation Bins {[AB(1,1), AB(1,2), AB(2,1), AB(2,2)], [AB(1,3), AB(1,4), AB(2,3), AB(2,4)],... } is folded together into a Folded Activation Bin {FAB(1,1), FAB(1,2),...}. For example, the 4 neighbor Activation Bins AB(1,1), AB(1,2), AB(2,1), AB(2,2) are folded together into Folded Activation Bin FAB(1,1), the 4 neighbor Activation Bins AB(1,3), AB(1,4), AB(2,3), AB(2,4) are folded together into Folded Activation Bin FAB(1,2), and so on. At the first set of clock-cycles the activations fetched from FAB(1,1) = [AB(1,1), later AB(1,2), later AB(2,1), and later AB(2,2)] are processed in MAC(1,1) and in parallel, FAB(1,2) in MAC(1,2) at a similar internal sequence, FAB(2,1) in MAC(2,1) at a similar internal sequence, and FAB(2,2) in MAC(2,2) at a similar internal sequence, and similarly the rest of the FABs and MACs. Later all the MAC units are processing the bin below, MAC(1,1) is processing AB(3,1) and later AB(3,2) inside FAB(2,1). All the other activations are skipped by using sparsity jumps (weight=0) in the Address Generators. All the other MACs are processing activations with similar offsets. Next MAC(1,1) is processing AB(1,3) and later AB(2,3) from the right neighbor bin. All the other activations are skipped by using sparsity jumps in the Address Generators. All the other MACs are processing activations with similar offsets. Next and last, MAC(1,1) is processing AB(3,3) from FAB(2,2). All the other activations are skipped by using sparsity jumps in the Address Generators. All the other MACs are processing activations with similar offsets. Each MAC, in this description, could be replaced by a group of MACs (for example 4 MACs or any other number of MACs) operating in Input Channels parallelism or in Output Channels parallelism to implement the vector multiply-accumulate operations on the weights and activations. By increasing the amount of bins folded together (generalization of this example) it is possible to implement larger kernels of convolution and/or larger distance strides.

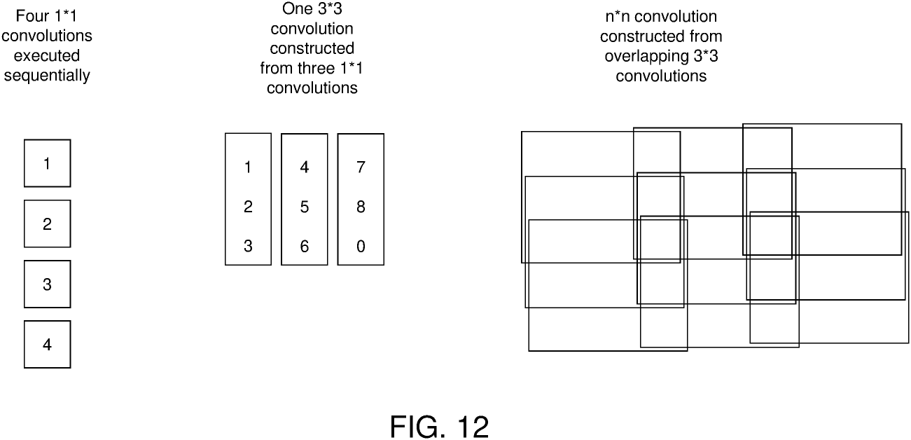

Implementation of embodiments herein on convolution neural networks may benefit from support of different size convolution operations such as 1*1 convolution, 3*3 convolution, 5*5 convolution, 7*7 convolution, and the like. Referring to FIG. 12, embodiments of the sDNA architecture disclosed herein may support reuse of hardware structures to implement the different convolution sizes in a specific neural network. In some embodiments, a 3*3 convolution operator may be constructed by reusing 1*1 sequential convolution blocks three times where a first three times (rows) are inside each column and then three different columns are executed one after the other. Other larger size convolution structures are implemented by reusing (overlapping) 3*3 convolution blocks or other, larger convolution blocks as illustrated in FIG. 12. The activation sequences (1*1, 3*3, etc.) of FIG. 12 may be related to the sequences they are stored in the AMM memory of FIG. 10.

Some portions of the detailed description refer to different modules, components, etc. configured to perform operations. One or more of the modules may include code and routines configured to enable a computing system to perform one or more of the operations described therewith. Additionally or alternatively, one or more of the modules may be implemented using hardware including any number of processors, microprocessors (e.g., to perform or control performance of one or more operations), DSPs, FPGAs, ASICs or any suitable combination of two or more thereof. Alternatively or additionally, one or more of the modules may be implemented using a combination of hardware and software. In the present disclosure, operations described as being performed by a particular module may include operations that the particular module may direct a corresponding system (e.g., a corresponding computing system) to perform. Further, the delineating between the different modules is to facilitate explanation of concepts described in the present disclosure. Further, one or more of the modules may be configured to perform more, fewer, and/or different operations than those described such that the modules may be combined or delineated differently than as described.

In general, all embodiments described herein can be freely combined, as applicable and if compatible. Further, the invention is not limited to the described embodiments, but can be varied within the scope of the enclosed claims.

Unless specific arrangements described herein are mutually exclusive with one another, the various implementations described herein can be combined in whole or in part to enhance system functionality or to produce complementary functions. Likewise, aspects of the implementations may be implemented in standalone arrangements. Thus, the above description has been given by way of example only and modification in detail may be made within the scope of the present invention.

With respect to the use of substantially any plural or singular terms herein, those having skill in the art can translate from the plural to the singular or from the singular to the plural as is appropriate to the context or application. The various singular/plural permutations may be expressly set forth herein for sake of clarity. A reference to an element in the singular is not intended to mean “one and only one” unless specifically stated, but rather “one or more.” Moreover, nothing disclosed herein is intended to be dedicated to the public regardless of whether such disclosure is explicitly recited in the above description.

In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). Furthermore, in those instances where a convention analogous to “at least one of A, B, and C, etc.” is used, in general, such a construction is intended in the sense one having skill in the art would understand the convention (e.g., “a system having at least one of A, B, and C” would include but not be limited to systems that include A alone, B alone, C alone, A and B together, A and C together, B and C together, or A, B, and C together, etc.). Also, a phrase presenting two or more alternative terms, whether in the description, claims, or drawings, should be understood to include one of the terms, either of the terms, or both terms. For example, the phrase “A or B” will be understood to include the possibilities of “A” or “B” or “A and B.”

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method of activation sparsity removal, comprising at least one of:
implementing a non-zero Activation jump algorithm; or
using multiple first in first out (FIFO) memories to store non-zero activations for each vector multiplication.

2. The method of claim 1, further comprising generating different combinations of vector multiplication tensors for machine learning models or algorithms.

3. The method of claim 1, further comprising supporting at least one of multiple different parallel modes including at least one of: a multiple points (pixels) parallel scheme, a lines parallel scheme, a multiple input channels parallel scheme, or a multiple output channels parallel scheme.

4. The method of claim 1, further comprising implementing a sequential execution NPU, a concurrent execution NPU, or a combination of a sequential execution NPU and a concurrent execution NPU to implement the vector multiplication.

5. The method of claim 4, wherein:
implementing a sequential execution NPU comprises storing back (feedback) an output of each neural network layer to a current AMM layer; and
implementing a concurrent execution NPU comprises allocating different hardware resources to different DNN layers to process the DNN layers in parallel (concurrently).

6. The method of claim 4, wherein:
implementing a sequential execution NPU comprises reusing hardware resources to calculate different layers of a same neural network; and
implementing a concurrent execution NPU comprises providing results of each DNN layer to another hardware logic that executes a next DNN layer.

7. The method of claim 1, further comprising supporting different size convolution operations.

8. The method of claim 7, wherein supporting different size convolution operations comprises supporting two different n*n convolution operations, and wherein n in a first of the convolution operations has a first value that is different than a second value of n in a second of the convolution operations.
